(19) United States
(12) Patent Application Publication
(10) Pub. No.: US 2007/0242052 A1
(43) Pub. Date: Oct. 18, 2007

(54) CURSOR DEVICE AND ELECTRONIC DEVICE

(75) Inventors: Wei-Po Lin, Taipei (TW); Hsiao-Hua Tai, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/695,623

(22) Filed: Apr. 3, 2007

(30) Foreign Application Priority Data
Apr. 17, 2006 (TW) 95113602

(51) Int. Cl. G06F 3/041

(52) U.S. Cl. 345/173

(57) ABSTRACT

A cursor device having a housing and a touch pad is provided. The housing has a first opening and a second opening. The touch pad is disposed inside the housing. The touch pad has regions exposed by the first opening and the second opening, respectively.

### CROSS-REFERENCE TO RELATED APPLICATION

This application claims the priority benefit of Taiwan application serial no. 95113602, filed Apr. 17, 2006. All disclosure of the Taiwan application is incorporated herein by reference.

### BACKGROUND OF THE INVENTION

1. Field of the Invention

The present invention relates to an electronic device, and more particularly to a cursor device with touch pad and an electronic device.

2. Description of Related Art

In the current information age, mankind's reliance on electronic products is increasing every day. To meet our demands for high performance and portable products, electronic products such as notebook personal computers (PC), cellular phones, personal digital assistants (PDA) and digital portable music players have been produced. These electronic products are so important that they have become indispensable tools in our work and our daily lives. To facilitate the users, all the foregoing electronic products have at least a man-machine interface for inputting instructions so that the internal operating system of the electronic product can respond by carrying out the instructions. At present, the most commonly used man-machine-interfaces include electronic devices such as keyboard, mouse and touch pad. In the following, the touch pad is explained in greater detail.

FIG. 1A is a perspective view of a conventional notebook computer. FIG. 1B is a schematic top view of the touch pad in FIG. 1A. The notebook computer 100 as shown in FIG. 1A includes a display screen 110, a base console 120 and a touch pad 130. The display screen 110 and the base console 120 are hinged together. The touch pad 130 is disposed inside the base console 120. In addition, the base console 120 has an opening 120a for exposing the touch pad 130.

More specifically, as shown in FIG. 1B, the touch pad 130 has a cursor-moving region 130a, a vertical-scrolling region 130b and a horizontal-scrolling region 130c. The cursor-moving region 130a is used for controlling the movement of the cursor, the vertical-scrolling region 130b is used for controlling the vertical scrolling of the window and the horizontal-scrolling region 130c is used for controlling the horizontal scrolling of the window. However, the cursor-moving region 130a, the vertical-scrolling region 130b and the horizontal-scrolling region 130c are linked together. Therefore, when a user uses the cursor-moving region 130a of the touch pad 130 to move the cursor, the vertical-scrolling region 130b or the horizontal-scrolling region 130c may be accidentally touched leading to a mis-judgement and a subsequent execution of an erroneous driving program.

### SUMMARY OF THE INVENTION

Accordingly, at least one objective of the present invention is to provide a cursor device that allows a user to use a touch pad more conveniently.

At least a second objective of the present invention is to provide a cursor device that minimizes the possibility of generating a mis-judgement when using a touch pad.

At least a third objective of the present invention is to provide an electronic device that allows a user to use a touch pad more conveniently.

To achieve these and other advantages and in accordance with the purpose of the invention, as embodied and broadly described herein, the invention provides a cursor device. The cursor device includes a housing and a touch pad. The housing has a first opening and a second opening. The touch pad is disposed inside the housing. The touch pad has a plurality of regions exposed by the first opening and the second opening, respectively.

In one embodiment of the present invention, the regions include a cursor-moving region and a first scrolling region. The first opening and the second opening expose the cursor-moving region and the first scrolling region, respectively.

In one embodiment of the present invention, the housing further includes a third opening and the regions further includes a second scrolling region. The third opening exposes the second scrolling region.

The present invention also provides an alternative cursor device. The cursor device includes a housing, a first touch pad and a second touch pad. The housing has a first opening and a second opening. The first touch pad is disposed inside the housing. The first opening exposes the first touch pad. The second touch pad is disposed inside the housing. The second opening exposes the second touch pad.

In one embodiment of the present invention, the first touch pad has a cursor-moving region and the second touch pad has a first scrolling region. The first opening and the second opening expose the cursor-moving region and the first scrolling region, respectively.

In one embodiment of the present invention, the cursor device further includes a third touch pad disposed inside the housing. The housing has a third opening that exposes the second scrolling region.

The present invention also provides an electronic device. The electronic device includes a display screen, a housing, a first touch pad and a second touch pad. The housing and the display screen are hinged together. The housing has a first opening and a second opening. The first touch pad is disposed inside the housing and exposed by the first opening. The second touch pad is disposed inside the housing and exposed by the second opening.

In one embodiment of the present invention, the first touch pad has a cursor-moving region and the second touch pad has a first scrolling region. The first opening and the second opening expose the cursor-moving region and the first scrolling region, respectively.

In one embodiment of the present invention, the electronic device further includes a third touch pad disposed inside the housing. The housing further includes a third opening that exposes a second scrolling region.

Accordingly, the present invention divides the touch pad into a plurality of regions through the housing to minimize the possibility of a user from accidentally touching the wrong part of the touch pad. In addition, using the housing to separate the touch pads, a user is able to use the touch pad more conveniently.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a perspective view of a conventional notebook computer.

FIG. 1B is a schematic top view of the touch pad in FIG. 1A.

FIG. 2A is a perspective view of an electronic device according to one embodiment of the present invention.

FIG. 2B is a top view of the touch pad in FIG. 2A.

FIG. 3 is a top view of a cursor device according to another embodiment of the present invention.

FIG. 4 is a top view of a cursor device according to yet another embodiment of the present invention.

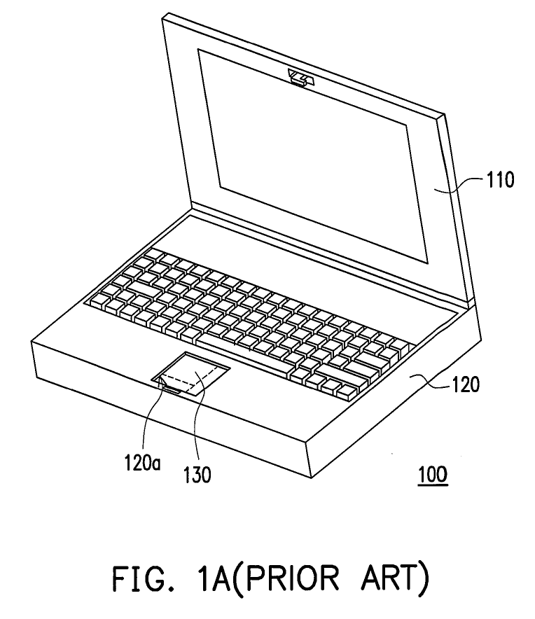

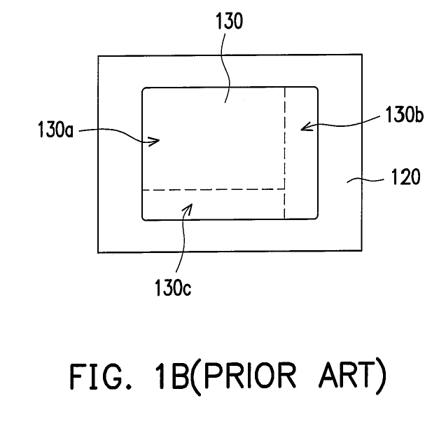

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

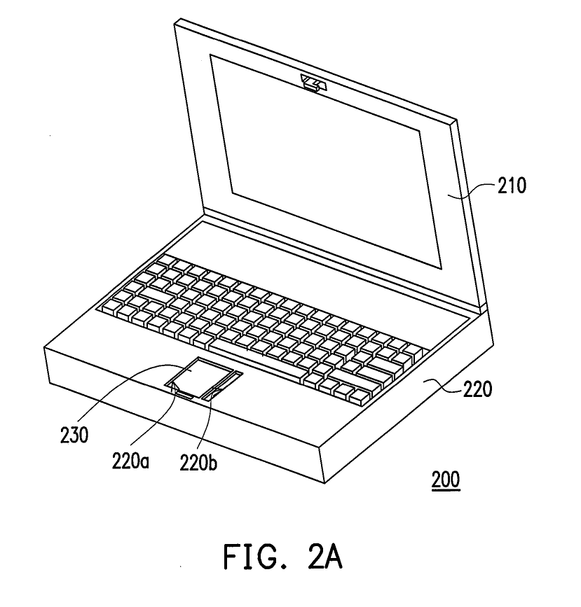

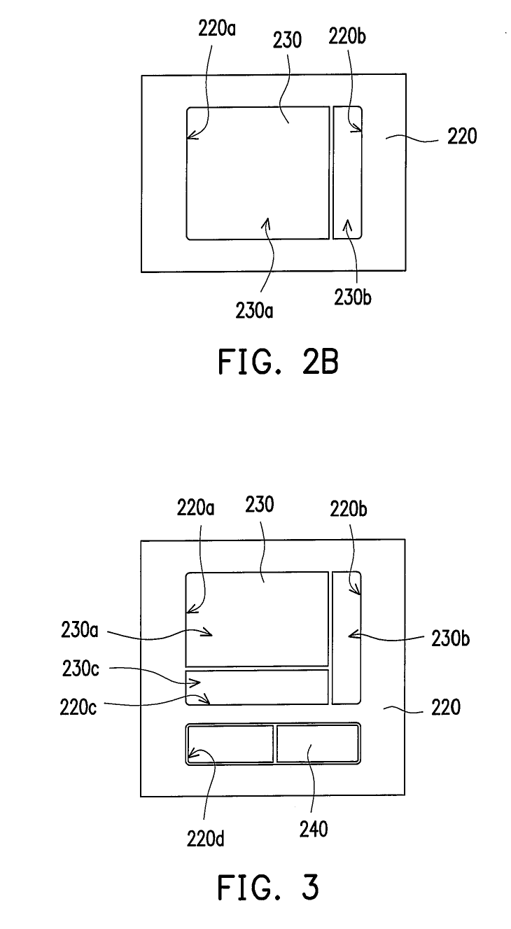

FIG. 2A is a perspective view of an electronic device according to one embodiment of the present invention. FIG. 2B is a top view of the touch pad in FIG. 2A. As shown in FIGS. 2A and 2b, the electronic device 200 in the present embodiment is a notebook computer, for example. The electronic device 200 includes a display screen 210, a housing 220 and a touch pad 230. The display screen 210 and the housing 220 are hinged together. Furthermore, the housing 220 has a first opening 220a and a second opening 220b. The touch pad 230 is disposed inside the housing 220 and has a cursor-moving region 230a and a first scrolling region 230b exposed by the first opening 220a and the second opening 220b respectively. In other words, the cursor-moving region 230a and the first scrolling region 230b are isolated from each other through the housing 220.

In the present embodiment, the first scrolling region 230b is a vertical-scrolling region. However, the first scrolling region 230b can equally be a horizontal-scrolling region. Because the cursor-moving region 230a and the first scrolling region 230b are separated from each other through the housing 220, it is not so easy for a user moving within the cursor-moving region 230a to accidentally touch the first scrolling region 230b. It should be noted that the assembly comprising the housing 220 and the touch pad 230 is called a cursor device in the present embodiment. Furthermore, the application of this type of cursor device is not limited to a notebook computer. For example, the cursor device can be applied to a PDA or other portable electronic devices. In other words, for any electronic device having at least a touch pad, the various regions of the touch pad may be isolated through the housing so that the possibility of a user touching the wrong part of a touch pad is minimized.

FIG. 3 is a top view of a cursor device according to another embodiment of the present invention. As s shown in FIG. 3, the cursor device is similar to the cursor device in FIG. 2B. The main difference is that the touch pad 230 has a second scrolling region 230c and the housing 220 further includes a third opening 220c. The third opening 220c exposes the second scrolling region 230c. In the present embodiment, the first scrolling region 230b is a vertical-scrolling region and the second scrolling region 220c is a horizontal-scrolling region, for example. Furthermore, the electronic device 200 may include a plurality of buttons 240 disposed inside the housing 220. Moreover, the housing also has a fourth opening that exposes these buttons 240.

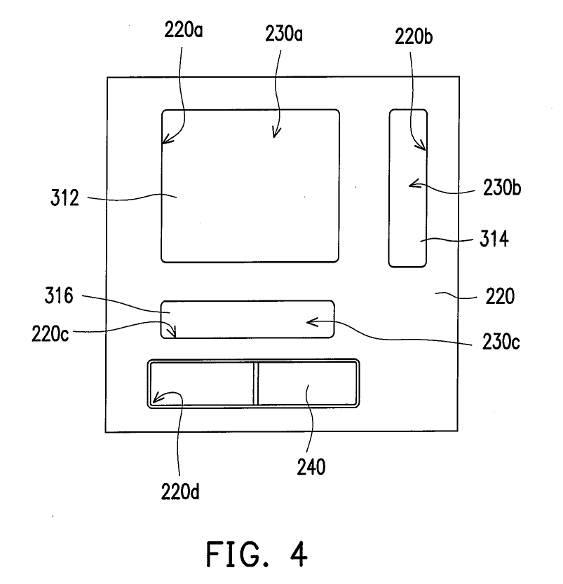

FIG. 4 is a top view of a cursor device according to yet another embodiment of the present invention. As shown in FIG. 4, the cursor device is similar to that shown in FIG. 3. The main differences are that the first opening 220a, the second opening 220b and the third opening 220c expose the firs touch pad 312, the second touch pad 314 and the third touch pad 316, respectively. In other words, the cursor device in FIG. 3 has a single touch pad while that shown in FIG. 4 has several touch pads. Furthermore, the first touch pad 312 is a cursor-moving region 230a, the second touch pad 314 is a first scrolling region 230b (for example, a vertical-scrolling region), for example. In addition, the third touch pad 316 is a second scrolling region 230c (for example, a horizontal-scrolling region), for example.

It should be noted that the single touch pad 230 in FIG. 2B can be modified to two touch pads that are exposed through the first opening 220a and the second opening 220b respectively.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A cursor device, comprising:
a housing having a first opening and a second opening; and
a touch pad disposed inside the housing, wherein the touch pad has a plurality of regions exposed by the first opening and the second opening respectively.

2. The cursor device of claim 1, wherein the regions comprise a cursor-moving region and a first scrolling, and the first opening and the second opening expose the cursor-moving region and the first scrolling region respectively.

3. The cursor device of claim 2, wherein the housing further comprises a third opening and the regions further comprise a second scrolling region such that the third opening exposes the second scrolling region.

4. A cursor device, comprising:
a housing having a first opening and a second opening;
a first touch pad disposed inside the housing and exposed through the first opening; and
a second touch pad disposed inside the housing and exposed through the second opening.

5. The cursor device of claim 4, wherein the first touch pad has a cursor-moving region and the second touch pad has a first scrolling region, and the cursor-moving region and the first scrolling region are exposed through the first opening and the second opening respectively.

6. The cursor device of claim 5, further comprises a third touch pad disposed inside the housing and the housing further comprises a third opening that exposes a second scrolling region in the third touch pad.

7. An electronic device, comprising:
a display screen;
a housing hinged to the display screen, wherein the housing has a first opening and a second opening;
a first touch pad disposed inside the housing, wherein the first touch pad is exposed through the first opening; and
a second touch pad disposed inside the housing, wherein the second touch pad is exposed through the second opening.

8. The electronic device of claim 7, wherein the first touch pad has a cursor-moving region and the second touch pad has a first scrolling region, and the cursor-moving region and the first scrolling region are exposed through the first opening and the second opening respectively.

9. The electronic device of claim 8, further comprises a third touch pad disposed inside the housing, and the housing has a third opening that exposes a second scrolling region in the third touch pad.
